(19) United States
(12) Patent Application Publication
(10) Pub. No.: US 2026/0170880 A1
(43) Pub. Date: Jun. 18, 2026

(54) SYSTEMS AND METHODS FOR ASSESSING A VEHICLE POWERTRAIN AND CHASSIS QUALITY OF ONE OR MORE COMPONENTS OF A VEHICLE

(71) Applicant: Ford Global Technologies, LLC, Dearborn, MI (US)

(72) Inventors: Stuart C. Salter, White Lake, MI (US); Krishna Bandi, Novi, MI (US); Vyas Darshan Shenoy, Canton, MI (US); Brendan Diamond, Naples, FL (US); Mario Anthony Santillo, Canton, MI (US)

(73) Assignee: Ford Global Technologies, LLC, Dearborn, MI (US)

(21) Appl. No.: 18/986,031

(22) Filed: Dec. 18, 2024

(51) Int. Cl. G07C 5/00; G07C 5/08

(52) U.S. Cl. CPC G07C 5/006; G07C 5/0808; G07C 5/0816

(57) ABSTRACT

A method includes the performance of one or more performance-based tasks as an automated vehicle moves through a marshaling environment, the assessment of a performance of one or more components of the automated vehicle, the determination of whether one or more results of the assessment exceed a performance-based threshold, and the transmission of an alert in response to the assessment exceeding the performance-based threshold.

### FIELD

The present disclosure relates to an assessment of one or more characteristics of a vehicle. More specifically, the present disclosure relates to the assessment of a vehicle powertrain and chassis quality of one or more components of the vehicle.

### BACKGROUND

The statements in this section merely provide background information related to the present disclosure and may not constitute prior art.

As vehicle marshaling advances towards a fully autonomous mode of transport, it is increasingly important for a vehicle to autonomously monitor a performance of one or more components of the vehicle. However, current systems rely on a human operator aiding in the inspection of the vehicle. Human inspection of the vehicle is a time consuming, and often inaccurate, means for assessing issues with many vehicle systems and/or vehicle components. The present disclosure addresses these and other issues related to the assessment of vehicle systems and/or components associated with the vehicle.

### SUMMARY

This section provides a general summary of the disclosure and is not a comprehensive disclosure of its full scope or all of its features.

The present disclosure provides a method comprising: performing, by an automated vehicle, one or more performance-based tasks as the automated vehicle moves through a marshaling environment; assessing a performance of one or more components of the automated vehicle in response to performing the one or more performance-based tasks; determining whether one or more results of the assessment exceed a performance-based threshold; and transmitting an alert in response to the assessment exceeding the performance-based threshold; wherein the alert is a service request; wherein the one or more performance-based tasks includes at least one of a chassis-based test, an acceleration-based test, an environment-based test, a usage-based test, or a combination thereof; wherein the one or more components of the automated vehicle includes a powertrain component, a chassis system, or a combination thereof, and wherein the assessment of the performance of the one or more components is performed internal to the automated vehicle, external to the automated vehicle, or a combination thereof; wherein one or more sensors of the automated vehicle is configured to assess the performance of the one or more components of the automated vehicle by monitoring a power variance, a torque variance, vehicle power, one or more torque capabilities, a temperature behavior, a vibrational variance, an acceleration variance, an accuracy of torque control, an accuracy of engine speed control, an accuracy of electric motor control, a capability of torque control, a capability of engine speed control, a capability of electric motor control, a maximum performance capability, a performance output, a battery charge, a battery discharge rate, an overall energy consumption level, or a combination thereof; wherein each of one or more sensors of the automated vehicle and one or more sensors of an infrastructure system are configured to assess the performance of the one or more components of the automated vehicle by performing a perception analysis of the automated vehicle, identifying vehicle fluid levels, identifying an oil leak, identifying a range of travel associated with the one or more components, monitoring one or more responses associated with the one or more components, or a combination thereof; and further comprising: performing one or more additional performance-based tasks in response to the assessment exceeding the performance-based threshold; and assessing the performance of the one or more components in response to a completion of the one or more additional performance-based tasks.

The present disclosure provides a system comprising: an infrastructure system configured to monitor movement of an automated vehicle through a marshaling environment; and the automated vehicle configured to: perform one or more performance-based tasks as the automated vehicle moves through a marshaling environment, assess a performance of one or more components of the automated vehicle in response to performing the one or more performance-based tasks, determine whether one or more results of the assessment exceed a performance-based threshold, and transmit an alert in response to the assessment exceeding the performance-based threshold; wherein the alert is a service request; wherein the one or more components of the automated vehicle includes a powertrain component, a chassis system, or a combination thereof, and wherein the assessment of the performance of the one or more components is performed internal to the automated vehicle, external to the automated vehicle, or a combination thereof; wherein one or more sensors of the automated vehicle is configured to assess the performance of the one or more components of the automated vehicle by monitoring a power variance, a torque variance, vehicle power, one or more torque capabilities, a temperature behavior, a vibrational variance, an acceleration variance, an accuracy of torque control, an accuracy of engine speed control, an accuracy of electric motor control, a capability of torque control, a capability of engine speed control, a capability of electric motor control, a maximum performance capability, a performance output, a battery charge, a battery discharge rate, an overall energy consumption level, or a combination thereof; wherein each of one or more sensors of the automated vehicle and one or more sensors of an infrastructure system are configured to assess the performance of the one or more components of the automated vehicle by performing a perception analysis of the automated vehicle, identifying vehicle fluid levels, identifying an oil leak, identifying a range of travel associated with the one or more components, monitoring one or more responses associated with the one or more components, or a combination thereof; and wherein the automated vehicle is further configured to: perform one or more additional performance-based tasks in response to the assessment exceeding the performance-based threshold; and assess the performance of the one or more components in response to a completion of the one or more additional performance-based tasks.

The present disclosure provides one or more non-transitory computer-readable media storing processor-executable instructions that, when executed by at least one processor, cause the at least one processor to: perform, by an automated vehicle, one or more performance-based tasks as the automated vehicle moves through a marshaling environment; assess a performance of one or more components of the automated vehicle in response to performing the one or more performance-based tasks; determine whether one or more results of the assessment exceed a performance-based threshold; and transmit a service request in response to the assessment exceeding the performance-based threshold; wherein the one or more performance-based tasks includes at least one of a chassis-based test, an acceleration-based test, an environment-based test, a usage-based test, or a combination thereof; wherein the one or more components of the automated vehicle includes a powertrain component, a chassis system, or a combination thereof, and wherein the assessment of the performance of the one or more components is performed internal to the automated vehicle, external to the automated vehicle, or a combination thereof; wherein one or more sensors of the automated vehicle is configured to assess the performance of the one or more components of the automated vehicle by monitoring a power variance, a torque variance, vehicle power, one or more torque capabilities, a temperature behavior, a vibrational variance, an acceleration variance, an accuracy of torque control, an accuracy of engine speed control, an accuracy of electric motor control, a capability of torque control, a capability of engine speed control, a capability of electric motor control, a maximum performance capability, a performance output, a battery charge, a battery discharge rate, an overall energy consumption level, or a combination thereof; wherein each of one or more sensors of the automated vehicle and one or more sensors of an infrastructure system are configured to assess the performance of the one or more components of the automated vehicle by performing a perception analysis of the automated vehicle, identifying vehicle fluid levels, identifying an oil leak, identifying a range of travel associated with the one or more components, monitoring one or more responses associated with the one or more components, or a combination thereof; and wherein the at least one processor is further caused to: perform one or more additional performance-based tasks in response to the assessment exceeding the performance-based threshold; and assess the performance of the one or more components in response to a completion of the one or more additional performance-based tasks.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example system for automated vehicle marshaling in accordance with one or more embodiments of the present disclosure;

FIG. 2 illustrates another example system for automated vehicle marshaling in accordance with one or more embodiments of the present disclosure;

FIG. 3 illustrates an example vehicle marshaled by the system shown in FIGS. 1 and 2 in accordance with one or more embodiments of the present disclosure;

FIG. 4 is a flowchart illustrating an example method for assessing quality of a powertrain and/or chassis associated with the vehicle in accordance with one or more embodiments of the present disclosure;

FIG. 5 is another flowchart illustrating an example method for assessing quality of a powertrain and/or chassis associated with the vehicle in accordance with one or more embodiments of the present disclosure; and

FIG. 6 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provides a means for assessing a vehicle powertrain and chassis quality of one or more components of an automated vehicle. More specifically, the overall-automated vehicle, powertrain components of the automated vehicle, and/or chassis component behavior is analyzed while the automated vehicle is under autonomous control that provides each component (e.g., of the automated vehicle) is within an acceptable range/expected variation during and/or after the automated vehicle is manufactured. In one or more examples, a vehicle exterior sensor suite and/or an infrastructure-based sensor suite is used. It is understood that one or more embodiments provide a fully automated means for assessing any issues with vehicle systems and/or vehicle components, and thus does not rely on human operators to perform any aspect of the assessment. Therefore, a more accurate and time-saving process to assessing the vehicle systems and/or components associated with the automated vehicle, particularly related to the vehicle powertrain and the chassis quality of the one or more components of the automated vehicle, is thereby provided in various examples.

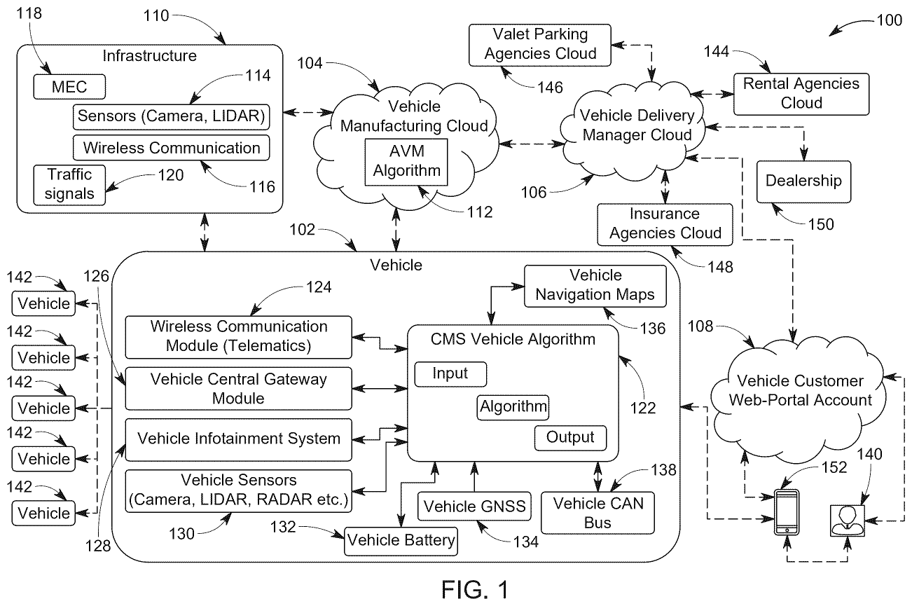

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

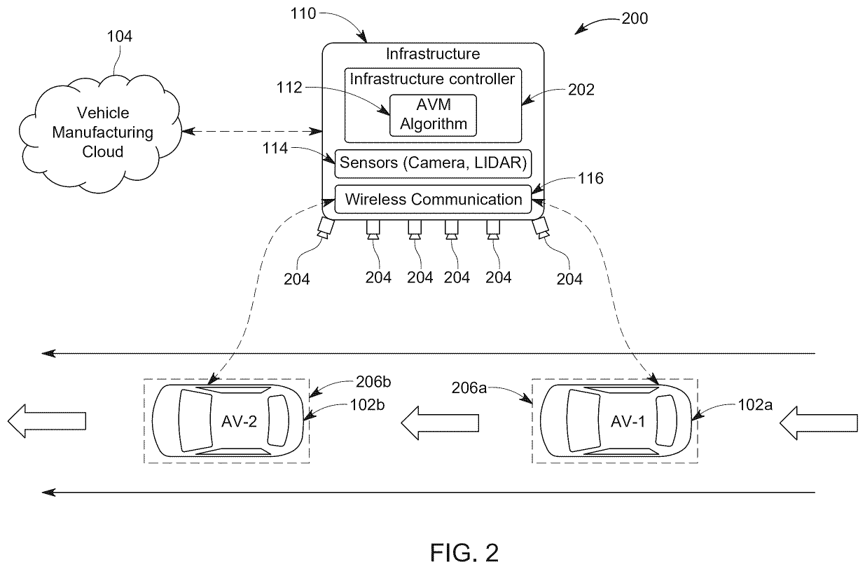

The vehicle manufacturing cloud system 104 can include an infrastructure-side AVM algorithm 112. However, it is understood that the infrastructure system 110 can include the infrastructure-side AVM algorithm 112 as well, as is shown in FIG. 2. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment. For example, the marshaling environment can represent a plant marshaling setting, an automated charging setting, a depot marshaling setting, an underground parking setting, among others. As an example, the plant marshaling setting can include an instance wherein just-built vehicles are moved through end-of-line testing at a vehicle assembly plant via overhead vision sensing (e.g., via a set of infrastructure sensors 204). As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the underground parking setting can include an instance wherein vehicles are moved through underground or covered parking environments with a potentially inconsistent communication network such as a global navigation satellite system.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is further configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes a sensor component 114, a wireless communication component 116, a multi-access edge computing (MEC) system 118, and one or more traffic signals 120. In general, and as is described herein, the infrastructure system 110 is configured to monitor and/or detect operational behavior (e.g., operational characteristics or conditions) of each vehicle of the one or more vehicles as the one or more vehicles move through the marshaling environment via a marshaling means.

In one or more embodiments, the infrastructure system 110 is configured to store an expected behavior associated with any vehicle that is configured to move through the marshaling environment. For example, the expected behavior is stored in a database (not shown) associated with the infrastructure system 110. As another example, the database can be disposed internally or externally in relation to the infrastructure system 110. As an example, the expected behavior that is stored can represent historical data used as a basis by which one or more analyses may be performed to determine one of more informational data points and/or statistical data associated with the operational behavior of each vehicle of the one or more vehicles, as is described herein. As another example, the expected behavior that is stored can relate to an expected behavior of a vehicle proximate to a particular workstation of one or more workstations associated with the marshaling environment.

In one or more examples, the infrastructure-side AVM algorithm 112 is configured to perform the one or more analyses to support the detection, identification, and/or verification of the operational behavior respective to each vehicle of the one or more vehicles. In one or more examples, the infrastructure-side AVM algorithm 112 is configured to verify the operational behavior respective to each vehicle of the one or more vehicles based on whether the identified operational behavior detected with respect to each vehicle of the one or more vehicles matches the expected behavior of the vehicle at a particular location within the marshaling environment. In one or more embodiments, and in an instance wherein the identified operational behavior of each vehicle of the one or more vehicles matches the expected behavior of the vehicle at the particular location within the marshaling environment, the infrastructure system 110 can cause each vehicle of the one or more vehicles to move from one workstation of the marshaling environment to another workstation of the marshaling environment. However, in another one or more embodiments, and in an instance wherein the identified operational behavior of each vehicle of the one or more vehicles does not match the expected behavior of the vehicle at the particular location within the marshaling environment, the infrastructure system 110 can transmit one or more operational commands to each vehicle of the one or more vehicles so that further operational behavior(s) of each vehicle of the one or more vehicles can be dynamically monitored, in real time. Additionally, in the instance wherein the identified operational behavior of each vehicle of the one or more vehicles does not match the expected behavior of the vehicle at the particular location within the marshaling environment, the infrastructure system 110 can cause each vehicle of the one or more vehicles to move to a repair bay in addition to transmitting the one or more operational commands to each vehicle of the one or more vehicles.

It is understood that the MEC system 118 is configured to support communication between the wireless communication component 116 and the vehicle 102. It is further understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth® to communicate with the one or more vehicles.

The wireless communication component 116 also communicates with the sensor component 114 that is configured to communicate with and/or manage the set of infrastructure sensors 204, as is described herein. In one or more examples, the sensor component 114 is also configured to perform one or more localization functions associated with marshaling the one or more vehicles such as, but not limited to, perception, path-planning, detection, controls, and/or receiving and analyzing response(s) from each vehicle of the one or more vehicles.

The wireless communication component 116 is also in communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110 such as, but not limited to, any operationally behavioral anomalies based on one or more expectations associated with the operational behavior of the vehicle 102 in one or more instances as the vehicle 102 moves within the marshaling environment. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits a wall or another vehicle and is then reflected back to the vehicle 102. Based on the amount of time it takes for the sound wave to return to the vehicle 102, the vehicle 102 can determine the distance between the one or more vehicle sensors 130 and the wall or the other vehicle. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the wall or the other vehicle and is then reflected back to the vehicle 102. Based on the amount of time it takes for the electromagnetic waves to return to the vehicle 102, the vehicle 102 can determine a range, velocity, and angle of the vehicle 102 relative to the wall or the other vehicle.

The one or more vehicle sensors 130 communicate information associated with the position and/or distance at which the vehicle 102 is relative to the wall or the other vehicle to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period of at least one day that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agencies cloud system 144, a valet parking agencies cloud system 146, an insurance agencies cloud system 148, and/or a dealership system 150. The vehicle delivery manager cloud system 106 is configured to facilitate the delivery of the one or more vehicles to any of a rental agency (not shown) associated with the rental agencies cloud system 144, a valet parking agency (not shown) associated with the valet parking agencies cloud system 146, an insurance agency (not shown) associated with the insurance agencies cloud system 148, and/or the dealership system 150. The vehicle delivery manager cloud system 106 also wirelessly communicates with the vehicle customer web-portal account cloud system 108. It should be understood that other cloud systems can be included, in one or more examples.

The vehicle delivery manager cloud system 106 wirelessly communicates with a user device 152 such as a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agencies cloud system 144, the valet parking agency associated with the valet parking agencies cloud system 146, the insurance agency associated with the insurance agencies cloud system 148, and/or the dealership system 150.

In one or more embodiments, FIG. 2 shows a system 200 that is an example embodiment of the AVM system 100 depicted in FIG. 1. More specifically, FIG. 2 illustrates the system 200 that facilitates maneuvering of one or more automated and/or semi-automated vehicles 102 (e.g., one or more vehicles 102a, 102b) within the marshaling environment. The system 200 includes the infrastructure system 110. The infrastructure system 110 includes the sensor component 114 that communicates with the set of infrastructure sensors 204 such as, for example, one or more cameras, lidar, radar, and/or ultrasonic devices. The set of infrastructure sensors 204 is configured to monitor the movement of the vehicle(s) 102 as the vehicle(s) 102 moves through the marshaling environment. In one or more examples, the set of infrastructure sensors 204 is configured to utilize a shared global coordinate system for monitoring the movement of the vehicle(s) 102 as the vehicle(s) 102 moves through the marshaling environment.

The infrastructure system 110 also includes the wireless communication component 116 that provides for communication between the infrastructure system 110 and the vehicle(s) 102. Additionally, the infrastructure system 110 includes an infrastructure controller 202. The infrastructure controller 202 is configured to centrally control an operation of each of the vehicles 102a, 102b in a closed loop control system. However, it is understood that the infrastructure controller 202 is configured to centrally control an operation of each of the vehicles 102a, 102b within the functional and/or technical bounds of any system. For example, the operation of each of the vehicles 102a, 102b include propulsion, braking, and/or steering of the vehicle(s) 102. It is understood that the infrastructure controller 202 may be disposed within the infrastructure system 110 or externally located relative to the infrastructure system 110.

In one or more embodiments, the infrastructure-side AVM algorithm (e.g., an AVM software module) 114 can create a bounding box 206 (e.g., one or more bounding boxes 206a, 206b as shown in FIG. 2) associated with the vehicle(s) 102. As an example, the bounding box 206 (e.g., a virtual vehicle layout) bounds the vehicle(s) 102 within a matrix grid. As another example, and to the extent that more than one vehicle 102 is being marshaled by the infrastructure system 110, the bounding boxes 206a, 206b respectively bound each vehicle 102a, 102b. As a further example, the creation (e.g., generation) of the bounding box(es) 206 can aid in accurate marshaling of the vehicle(s) 102 through the marshaling environment and can thus support the operational functionality of an infrastructure sensor suite and/or a vehicle sensor suite.

In one or more embodiments, the AVM system 100 also includes the vehicle manufacturing cloud system 104 that can operate as the central cloud system that manages and/or facilitates the manufacturing process associated with the vehicle(s) 102 described herein. In one or more examples, the infrastructure system 110 is configured to wirelessly communicate with the vehicle manufacturing cloud system 104, and in some instances, the vehicle manufacturing cloud system 104 is configured to cause the infrastructure system 110 to monitor the progression of the vehicle(s) 102 as the vehicle(s) 102 progress through the marshaling environment, as is described herein.

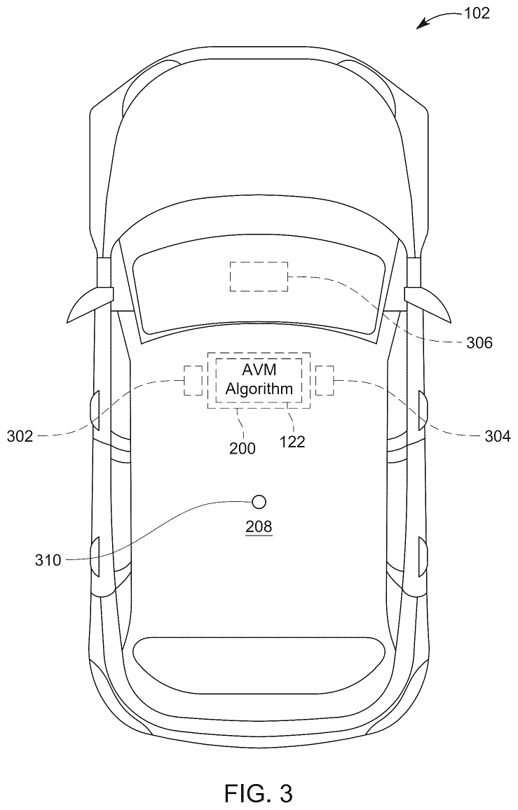

Referring further to FIG. 3, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally includes a vehicle controller 300, the one or more actuators 302, the plurality of on-board sensors 304, the HMI 306, and the vehicle system 308. The vehicle(s) 102 also has a reference point 310, that is, a specified point within a space defined by a vehicle body that identifies the location of the vehicle(s) 102. For example, the reference point 310 is a geometrical center point at which respective longitudinal and lateral center axes of the vehicle(s) 102 intersects. As another example, the reference point 310 is a point at which the vehicle(s) 102 is located as the vehicle(s) 102 navigates toward a waypoint.

The plurality of on-board sensors 304 includes a variety of devices to provide data to the vehicle controller 300. For example, the plurality of on-board sensors 304 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 304 can be radar sensor(s) affixed to one or more bumpers of the vehicle(s) 102 that may provide locations of the object(s) relative to the location of each of the vehicles 102. As yet another example, one or more of the plurality of on-board sensors 304 can be configured to monitor one or more functionalities associated with one or more internally-based components of the vehicle(s) 102.

The plurality of on-board sensors 304 may include a camera sensor, for example, to provide a front view, side view, rear view, etc., providing images from an area surrounding the vehicle(s) 102. As another example, the vehicle controller 300 may be programmed to receive sensor data from a camera sensor(s) and to implement image processing techniques to detect a road, infrastructure elements, etc. The vehicle controller 300 may be programmed to determine a current vehicle location based on location coordinates (e.g., GPS coordinates) received from the vehicle(s) 102 indicative of a location of the vehicles 102 from a GPS sensor (not shown).

The vehicle controller 300, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 300, in other examples, is further configured or programmed to determine whether and when the vehicle controller 300, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 300 without the aid of the human operator. As another example, the semi-automated mode may facilitate any of the operations to be at least partially controlled by the human operator in combination with the vehicle controller 300. As a further example, the manual mode may facilitate the operations to be fully controlled by the human operator without the aid of the vehicle controller 300.

The vehicle controller 300 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 300 is generally arranged for various communications on a vehicle communication network (not shown) that can include a bus in the vehicle(s) 102 such as a CAN, or the like, and/or other wired and/or wireless mechanisms.

Via a vehicle network, the vehicle controller 300 transmits messages to various devices in the vehicle(s) 102 and/or receives messages from the various devices, for example, the one or more actuators 302, the HMI 306, etc. Alternatively, or additionally, in cases where the vehicle controller 300 includes multiple devices, the vehicle communication network is utilized for communications between devices represented as the vehicle controller 300 in this disclosure. Further, as is discussed below, various other controllers and/or sensors provide data to the vehicle controller 300 via the vehicle communication network.

In addition, the vehicle controller 300, via the vehicle-side AVM algorithm 122, is configured for communicating through a vehicle-to-infrastructure communication network, such as identifying the trajectory of the vehicle(s) 102 relative to the target path of travel.

In one or more embodiments, the vehicle-side AVM algorithm 122 is configured to assess a performance of one or more components of the vehicle(s) 102 in response to the vehicle(s) 102 performing one or more performance-based tasks. In one or more examples, the one or more performance-based tasks is performed by each vehicle of the one or more vehicles moving along a similar pathway within the marshaling environment based on a particular assessment. In one or more examples, the one or more components of the vehicle(s) 102 can include, but is not limited to, a powertrain component, a chassis system, or a combination thereof. It is understood that the one or more components of the vehicle(s) 102 can include any number of components associated with the functionality of the vehicle(s) 102 in relation to the performance of the one or more performance-based tasks.

For example, the assessment can be related to, but is not limited to, chassis-based testing, performance-based testing, special environment-based testing, and/or customer usage-based testing. It is understood that the assessment provides a bases for the vehicle-side AVM algorithm 122 to assess the performance related to any functionality associated with each vehicle of the one or more vehicles. It is also understood that the bases for the vehicle-side AVM algorithm 122 considers how the performance of the one or more performance-based tasks affects the one or more components of the vehicle(s) 102.

In one or more examples, the chassis-based testing can include, but is not limited to, the vehicle(s) 102 pushing over one or more wheel chocks, moving up and/or down ramps of varying angular elevations, turning at various radii, and/or moving over and/or around one or more obstacles. In one or more examples, the performance-based testing can include, but is not limited to, the vehicle(s) 102 going from 0 mph to 60 mph (or between other speeds) and/or towing an object while moving. In one or more examples, the special environment-based testing can include, but is not limited to, testing the performance related to one or more functionalities of the vehicle(s) 102 in a hot chamber or a cold chamber. In one or more examples, the customer usage-based testing can include, but is not limited to, one or more external loads being applied to the vehicle(s).

In one or more embodiments, the assessment can be performed internally within the vehicle(s) 102. In one or more examples, the plurality of on-board sensors 304 can be configured to assess the performance of the one or more components of the vehicle(s) 102 relative to a power variance that may be used by the vehicle(s) 102 to overcome one or more obstacles of the performance-based tasks. In one or more examples, the plurality of on-board sensors 304 can also be configured to assess the performance of the one or more components of the vehicle(s) 102 relative to a torque variance that may be used by the vehicle(s) 102 to overcome the one or more obstacles of the performance-based tasks. For example, the assessment of the performance of the one or more components of the vehicle(s) 102 relative to the power variance and/or the torque variance can include monitoring (e.g., by the plurality of on-board sensors 304) of a speed at which the vehicle(s) 102 may use to perform the one or more performance-based tasks.

In one or more examples, the plurality of on-board sensors 304 can further be configured to assess one or more of a vehicle power, torque capabilities, and/or a temperature behavior that may result from the performance of the one or more components of the vehicle(s) 102 in response to the vehicle(s) 102 performing the one or more performance-based tasks. In one or more examples, the plurality of on-board sensors 304 can additionally be configured to assess one or more of a vibrational variance and/or an acceleration variance that may result from the performance of the one or more components of the vehicle(s) 102 in response to the vehicle(s) 102 performing the one or more performance-based tasks.

In one or more examples, the plurality of on-board sensors 304 can be configured to assess the performance of the one or more components of the vehicle(s) 102 relative to an accuracy of the vehicle(s) 102 ability to control one or more of a torque applied by the vehicle(s) 102, a speed of an engine associated with the vehicle(s) 102, and/or an electric motor associated with the vehicle(s) 102. In one or more examples, the plurality of on-board sensors 304 can be configured to assess the performance of the one or more components of the vehicle(s) 102 relative to a capability of the vehicle(s) 102 ability to control one or more of the torque applied by the vehicle(s) 102, the speed of an engine associated with the vehicle(s) 102, and/or the electric motor associated with the vehicle(s) 102.

In one or more examples, the plurality of on-board sensors 304 can be further be configured to assess the performance of the one or more components of the vehicle(s) 102 relative to one or more of a maximum performance capability of the vehicle(s) 102, a performance output of the vehicle(s) 102, a battery (e.g., a low-voltage battery or a high-voltage battery) charge-level associated with the vehicle(s) 102, and/or an overall energy consumption of the vehicle(s) 102.

In one or more embodiments, the assessment can also be performed externally in relation to the vehicle(s) 102. In one or more examples, the vehicle-side AVM algorithm 122 can perform one or more analyses based on the assessment of the performance of the one or more components of the vehicle(s) 102 relative to any of the performance-based tasks. As an example, the one or more analyses can include a perception analysis that can include a field of vision analysis, a power analysis, a signal strength of reflected beams, an identification of one or more objects, distance measurements, detection accuracy, or a combination thereof. However, it is understood that the one or more analyses can include any other type of analysis. In one or more examples, the perception analysis can be used to identify vehicle fluid levels associated with the vehicle(s) 102, identify an oil leak associated with the vehicle(s) 102, identify a range of travel associated with the one or more components of the vehicle(s) 102, monitoring one or more responses associated with the one or more components of the vehicle(s) 102, or a combination thereof.

It is understood that the one or more performance-based tasks can be formulated to cause the use of as many of the one or more components of the vehicle(s) 102 as is possible with relation to the functionalities of the vehicle(s) 102. In one or more embodiments, the vehicle(s) 102 can be caused to perform a powertrain and chassis quality assessment by moving over one or more angled bumps (e.g., one or more obstacles) that rocks (e.g., sways) the vehicle(s) 102 from one side to another side as the vehicle(s) 102 moves about the marshaling environment. In one or more examples, the set of infrastructure sensors 204 can monitor the progression of the vehicle(s) 102 associated with completion of the one or more performance-based tasks to determine a wheel alignment of the vehicle(s) 102. In this instance, one or more time-stamped data points can be obtained (e.g., by the vehicle-side AVM algorithm 122) from the swaying of the vehicle(s) 102. For example, the one or more time-stamped data points can be obtained from one or more ride height sensors of the vehicle(s) 102, a throttle sensor of the vehicle(s) 102, and/or one or more brake sensors of the vehicle(s) 102. However, it is understood that any other embodiments associated with various performance-based tasks are contemplated and that the embodiments described herein should only be taken as, non-limiting, example use-cases.

The vehicle controller 300, via the vehicle-side AVM algorithm 122, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 300 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 302 are implemented via circuits, chips, or other electronic and/or mechanical components that can actuate various vehicle subsystems in accordance with appropriate control signals. The actuators 302 may be used to control braking, acceleration, and/or steering of the vehicle(s) 102. The vehicle controller 300 can be programmed to activate the one or more actuators 302 including propulsion, steering, and/or braking based on the planned acceleration or deceleration of the vehicle(s) 102.

The HMI 306 is configured to receive information from the human operator during operation of the vehicle(s) 102. Moreover, the HMI 306 is configured to present information to the human operator, such as, an occupant of the vehicle(s) 102. In some variations, the vehicle controller 300 is programmed to receive destination data (e.g., location coordinates) from the HMI 306.

The vehicle system 308 is configured to control each of the subsystems within the vehicle(s) 102 and facilitate requests across each of the above-described components (e.g., the vehicle controller 300, the one or more actuators 302, the plurality of on-board sensors 304, and/or the HMI 306). Accordingly, the vehicle(s) 102 can be autonomously guided toward a waypoint using at least the plurality of on-board sensors 304. Routing can be performed using vehicle location, distance to travel, queue in line for vehicle marshaling, etc.

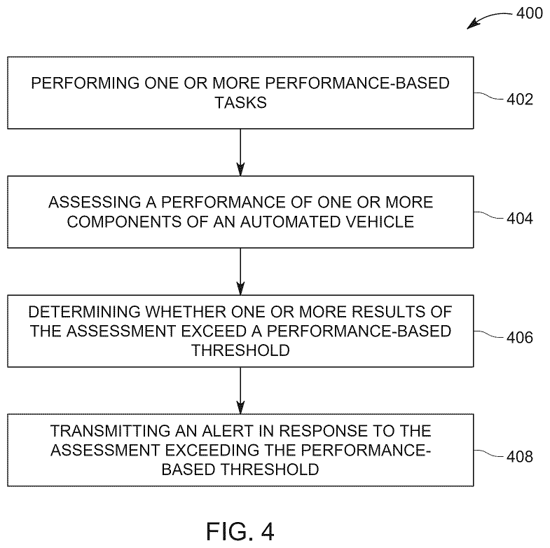

FIG. 4 is a flowchart illustrating an example method 400 for assessing a quality of a powertrain and/or a chassis associated with an automated vehicle (e.g., the vehicle 102). At operation 402, the automated vehicle is configured to perform one or more performance-based tasks. In one or more examples, the automated vehicle is configured to perform the one or more performance-based tasks as the automated vehicle moves through a marshaling environment. As another example, the one or more performance-based tasks includes at least one of a chassis-based test, an acceleration-based test, an environment-based test, a usage-based test, or a combination thereof.

At operation 404, an assessment of a performance of one or more components of the automated vehicle is made. For example, the assessment is made by the automated vehicle. In one or more examples, the assessment of the performance of the one or more components of the automated vehicle is made in response to the performance of the one or more performance-based tasks. As another example, the one or more components of the automated vehicle includes a powertrain component, a chassis system, or a combination thereof. As yet another example, the assessment of the performance of the one or more components is performed internal to the automated vehicle, external to the automated vehicle, or a combination thereof.

In one or more embodiments, one or more sensors (e.g., the plurality of on-board sensors 304) of the automated vehicle is configured to assess the performance of the one or more components of the automated vehicle by monitoring a power variance, a torque variance, vehicle power, one or more torque capabilities, a temperature behavior, a vibrational variance, an acceleration variance, an accuracy of torque control, an accuracy of engine speed control, an accuracy of electric motor control, a capability of torque control, a capability of engine speed control, a capability of electric motor control, a maximum performance capability, a performance output, a battery charge, a battery discharge rate, an overall energy consumption level, or a combination thereof.

In one or more examples, each of one or more sensors of the automated vehicle and one or more sensors (e.g., the set of infrastructure sensors 204) of an infrastructure system (e.g., the infrastructure system 110) are configured to assess the performance of the one or more components of the automated vehicle by performing a perception analysis of the automated vehicle, identifying vehicle fluid levels, identifying an oil leak, identifying a range of travel associated with the one or more components, monitoring one or more responses associated with the one or more components, or a combination thereof.

At operation 406, the automated vehicle is also configured to determine whether one or more results of the assessment exceed a performance-based threshold. It is understood that the performance-based threshold can represent a predefined range associated with the one or more results that is indicative of an acceptable variation of an expected behavior of the automated vehicle in performing the one or more performance-based tasks.

At operation 408, the automated vehicle is further configured to transmit an alert in response to the assessment exceeding the performance-based threshold. In one or more examples, the alert is a service request. However, it is understood that the alert can be a notification related to any type of request associated with the automated vehicle.

In one or more embodiments, the automated vehicle is additionally configured to perform one or more additional performance-based tasks in response to the assessment exceeding the performance-based threshold. The automated vehicle is then configured to assess the performance of the one or more components in response to a completion of the one or more additional performance-based tasks.

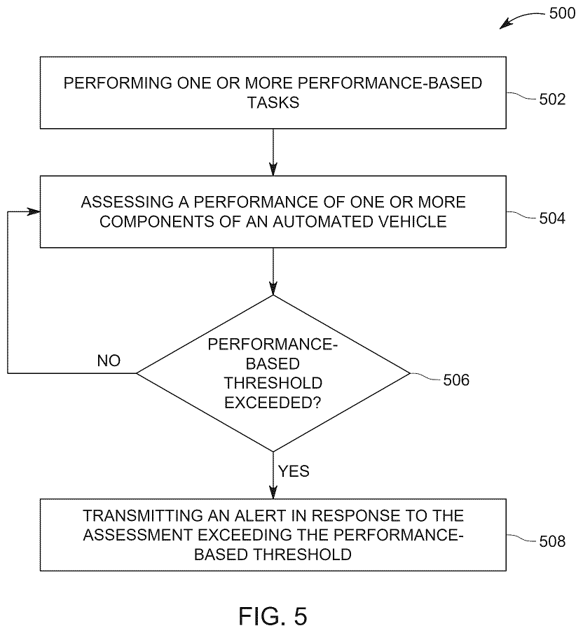

FIG. 5 is a flowchart illustrating another example method 500 for assessing a quality of a powertrain and/or a chassis associated with an automated vehicle (e.g., the vehicle 102). At operation 502, the automated vehicle is configured to perform one or more performance-based tasks. In one or more examples, the automated vehicle is configured to perform the one or more performance-based tasks as the automated vehicle moves through a marshaling environment.

At operation 504, an assessment of a performance of one or more components of the automated vehicle is made. For example, the assessment is made by the automated vehicle. In one or more examples, the assessment of the performance of the one or more components of the automated vehicle is made in response to the performance of the one or more performance-based tasks.

At operation 506, the automated vehicle is further configured to make a determination regarding whether the one or more results of the assessment exceed a performance-based threshold. It is understood that the performance-based threshold can represent a predefined range associated with the one or more results that is indicative of an acceptable variation of an expected behavior of the automated vehicle in performing the one or more performance-based tasks. In one or more embodiments, the determination regarding whether the one or more results of the assessment exceed the performance-based threshold can be based on a performance of a statistical analysis of the one or more results. In one or more examples, and in an instance wherein a determination is made that the one or more results of the assessment do not exceed the performance-based threshold, the assessment of the performance of the one or more components of the automated vehicle (e.g., at operation 504) is repeated.

However, in other examples, and in an instance wherein a determination is made at operation 506 that the one or more results of the assessment exceed the performance-based threshold, the automated vehicle is further configured to transmit an alert in response to the assessment exceeding the performance-based threshold at operation 508. In one or more examples, the alert can be a service request. However, it is understood that the alert can be a notification related to any type of request associated with the automated vehicle that can cause the automated vehicle to be marshaled toward a repair bay or inspection-related workstation. In one or more examples, the alert can include information associated with one or more conditions that may explain why and/or how the one or more results of the assessment exceed the performance-based threshold.

In one or more examples, the automated vehicle can be caused to perform one or more additional performance-based tasks in response to the assessment exceeding the performance-based threshold, which in turn causes an additional assessment of the performance of the one or more components of the automated vehicle to be made, in response to a completion of the one or more additional performance-based tasks.

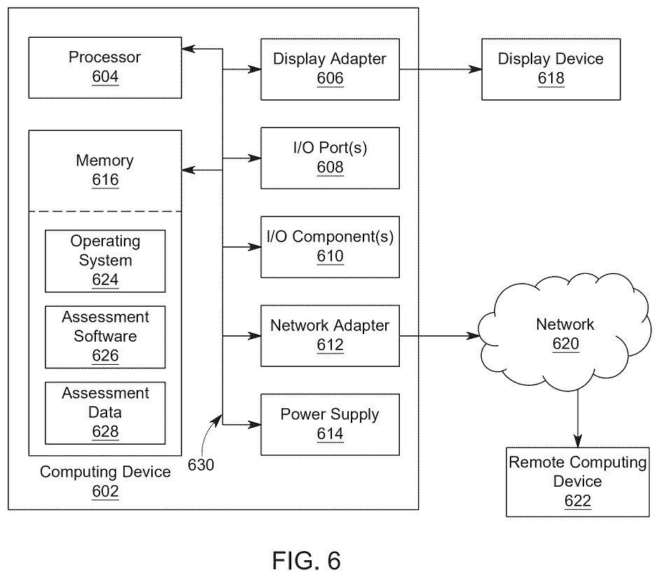

FIG. 6 illustrates an operating environment, such as a computer system, that facilitates the performance of the one or more systems and methods described herein. More specifically, the systems and methods described herein can be implemented using a computing device 602. For example, the computing device 602 can be a personal computer, a desktop, a laptop, a tablet, a hand-held computer, a server, a workstation, a mainframe, a wearable computer, a supercomputer, or a combination thereof. However, it is understood that the aforementioned examples of the computing device 602 is non-exhaustive and the computing device 602 can be any type of processing or computing device. The computing device 602 generally includes a processor 604, a display adapter 606, one or more input/output port(s) 608, one or more input/output component(s) 610, a network adapter 612, a power supply 614, and a memory 616. However, it is understood that the computing device 602 can include any additional components therein and is not required to include any of the listed components (e.g., the processor 604, the display adapter 606, the one or more input/output port(s) 608, the one or more input/output component(s) 610, the network adapter 612, the power supply 614, and the memory 616).

The processor 604 is configured to provide instructions to the computing device 602 so that the computing device 602 can process one or more tasks including the implementation of a software program to perform one or more operations as described in more detail herein. It is also understood that the computing device 602 may include any number or processors 604 therein. The display adapter 606 can be a graphics card or a video board that provides the computing device 602 with a capability to display content on a display device 618. For example, the display device 618 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 618 is non-exhaustive and that the display device 618 can be any type of device capable of providing a visual display.

The input/output port(s) 608 provide a number of interfaces (e.g., sockets) for one or more cables to connect to the computing device 602. It is understood that there may be any number of input/output port(s) 608 on the computing device 602. For example, the input/output port(s) 608 provides a means for the computing device 602 to receive signals and/or data from an external device connected to the computing device 602 via the one or more cables. As another example, the input/output port(s) 608 provide a means for the computing device 602 to send signals and/or data to an external device connected to the computing device 602 via the one or more cables. The input/output component(s) 610 can include one or more components that support the input/output port(s) 608 such as, but not limited to, a switch, a push button, a pressure mat, a float switch, a keypad, a radio receive, or a combination thereof.

The network adapter 612 can be any type of network interface controller that is configured to provide a means for communicating over a network 620 with another computing device, such as a remote computing device 622. For example, the remote computing device 622 can be a user device such as a cellular-phone, a smartphone, a tablet, a laptop, or a combination thereof. The power supply 614 is configured to convert alternating high voltage current (e.g., AC) into direct current (e.g., DC) to provide power to the other components (e.g., the processor 604, the display adapter 606, the one or more input/output port(s) 608, the one or more input/output component(s) 610, the network adapter 612, and the memory 616) of the computing device 602.

Additionally, the memory 616 can be a mass storage device and/or a system memory such as a hard disk drive, a memory card, a solid-state drive, random access memory (RAM), or a combination thereof. The memory 616 is configured to provide storage for instructions and data associated with the operation of the computing device 602. The memory 616 can generally include an operating system 624, assessment software 626, and assessment data 628. For example, the operating system 624 is configured to manage and/or process any of the data and/or instructions associated with the assessment software 626 and/or assessment data 628, as described in more detail herein.

Furthermore, a system bus 630 is also included within the computing device 602 that is configured to couple each of the various components (e.g., the processor 604, the display adapter 606, the one or more input/output port(s) 608, the one or more input/output component(s) 610, the network adapter 612, the power supply 614, and the memory 616) of the computing device 602. It is also understood that each of the components of the computing device 602, and the functionality associated with each of the components of the computing device 602, may be implemented within the remote computing device 622. While the operating environment illustrated within FIG. 6 depicts a particular configuration associated with at least the computing device 602, the network 620, and the remote computing device 622, it is understood that the operating environment may be configured in any way.

Thus, one or more examples of the present disclosure provides a means for assessing a vehicle powertrain and chassis quality of one or more components of an automated vehicle by utilizing a vehicle exterior sensor suite and/or an infrastructure-based sensor suite to monitor an operational behavior of the vehicle.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
performing, by an automated vehicle, one or more performance-based tasks as the automated vehicle moves through a marshaling environment;
assessing a performance of one or more components of the automated vehicle in response to performing the one or more performance-based tasks;
determining whether one or more results of the assessment exceed a performance-based threshold; and
transmitting an alert in response to the assessment exceeding the performance-based threshold.

2. The method of claim 1, wherein the alert is a service request.

3. The method of claim 1, wherein the one or more performance-based tasks includes at least one of a chassis-based test, an acceleration-based test, an environment-based test, a usage-based test, or a combination thereof.

4. The method of claim 1, wherein the one or more components of the automated vehicle includes a powertrain component, a chassis system, or a combination thereof, and wherein the assessment of the performance of the one or more components is performed internal to the automated vehicle, external to the automated vehicle, or a combination thereof.

5. The method of claim 1, wherein one or more sensors of the automated vehicle is configured to assess the performance of the one or more components of the automated vehicle by monitoring a power variance, a torque variance, vehicle power, one or more torque capabilities, a temperature behavior, a vibrational variance, an acceleration variance, an accuracy of torque control, an accuracy of engine speed control, an accuracy of electric motor control, a capability of torque control, a capability of engine speed control, a capability of electric motor control, a maximum performance capability, a performance output, a battery charge, a battery discharge rate, an overall energy consumption level, or a combination thereof.

6. The method of claim 1, wherein each of one or more sensors of the automated vehicle and one or more sensors of an infrastructure system are configured to assess the performance of the one or more components of the automated vehicle by performing a perception analysis of the automated vehicle, identifying vehicle fluid levels, identifying an oil leak, identifying a range of travel associated with the one or more components, monitoring one or more responses associated with the one or more components, or a combination thereof.

7. The method of claim 1, further comprising:
performing one or more additional performance-based tasks in response to the assessment exceeding the performance-based threshold; and
assessing the performance of the one or more components in response to a completion of the one or more additional performance-based tasks.

8. A system comprising:
an infrastructure system configured to monitor movement of an automated vehicle through a marshaling environment; and
the automated vehicle configured to:
perform one or more performance-based tasks as the automated vehicle moves through a marshaling environment,
assess a performance of one or more components of the automated vehicle in response to performing the one or more performance-based tasks,
determine whether one or more results of the assessment exceed a performance-based threshold, and
transmit an alert in response to the assessment exceeding the performance-based threshold.

9. The system of claim 8, wherein the alert is a service request.

10. The system of claim 8, wherein the one or more performance-based tasks includes at least one of a chassis-based test, an acceleration-based test, an environment-based test, a usage-based test, or a combination thereof.

11. The system of claim 8, wherein the one or more components of the automated vehicle includes a powertrain component, a chassis system, or a combination thereof, and wherein the assessment of the performance of the one or more components is performed internal to the automated vehicle, external to the automated vehicle, or a combination thereof.

12. The system of claim 8, wherein one or more sensors of the automated vehicle is configured to assess the performance of the one or more components of the automated vehicle by monitoring a power variance, a torque variance, vehicle power, one or more torque capabilities, a temperature behavior, a vibrational variance, an acceleration variance, an accuracy of torque control, an accuracy of engine speed control, an accuracy of electric motor control, a capability of torque control, a capability of engine speed control, a capability of electric motor control, a maximum performance capability, a performance output, a battery charge, a battery discharge rate, an overall energy consumption level, or a combination thereof.

13. The system of claim 8, wherein each of one or more sensors of the automated vehicle and one or more sensors of an infrastructure system are configured to assess the performance of the one or more components of the automated vehicle by performing a perception analysis of the automated vehicle, identifying vehicle fluid levels, identifying an oil leak, identifying a range of travel associated with the one or more components, monitoring one or more responses associated with the one or more components, or a combination thereof.

14. The system of claim 8, wherein the automated vehicle is further configured to:
perform one or more additional performance-based tasks in response to the assessment exceeding the performance-based threshold; and
assess the performance of the one or more components in response to a completion of the one or more additional performance-based tasks.

15. One or more non-transitory computer-readable media storing processor-executable instructions that, when executed by at least one processor, cause the at least one processor to:
perform, by an automated vehicle, one or more performance-based tasks as the automated vehicle moves through a marshaling environment;
assess a performance of one or more components of the automated vehicle in response to performing the one or more performance-based tasks;
determine whether one or more results of the assessment exceed a performance-based threshold; and
transmit a service request in response to the assessment exceeding the performance-based threshold.

16. The one or more non-transitory computer-readable media of claim 15, wherein the one or more performance-based tasks includes at least one of a chassis-based test, an acceleration-based test, an environment-based test, a usage-based test, or a combination thereof.

17. The one or more non-transitory computer-readable media of claim 15, wherein the one or more components of the automated vehicle includes a powertrain component, a chassis system, or a combination thereof, and wherein the assessment of the performance of the one or more components is performed internal to the automated vehicle, external to the automated vehicle, or a combination thereof.

18. The one or more non-transitory computer-readable media of claim 15, wherein one or more sensors of the automated vehicle is configured to assess the performance of the one or more components of the automated vehicle by monitoring a power variance, a torque variance, vehicle power, one or more torque capabilities, a temperature behavior, a vibrational variance, an acceleration variance, an accuracy of torque control, an accuracy of engine speed control, an accuracy of electric motor control, a capability of torque control, a capability of engine speed control, a capability of electric motor control, a maximum performance capability, a performance output, a battery charge, a battery discharge rate, an overall energy consumption level, or a combination thereof.

19. The one or more non-transitory computer-readable media of claim 15, wherein each of one or more sensors of the automated vehicle and one or more sensors of an infrastructure system are configured to assess the performance of the one or more components of the automated vehicle by performing a perception analysis of the automated vehicle, identifying vehicle fluid levels, identifying an oil leak, identifying a range of travel associated with the one or more components, monitoring one or more responses associated with the one or more components, or a combination thereof.

20. The one or more non-transitory computer-readable media of claim 15, wherein the at least one processor is further caused to:
perform one or more additional performance-based tasks in response to the assessment exceeding the performance-based threshold; and
assess the performance of the one or more components in response to a completion of the one or more additional performance-based tasks.
